(19) United States
(12) Patent Application Publication
(10) Pub. No.: US 2002/0075246 A1
(43) Pub. Date: Jun. 20, 2002

(54) Method of voting based on the dual input data entry paradigm

(76) Inventor: Alexander Y. Zheltukhin, Roswell, GA (US)

Correspondence Address: Alexander Y. Zheltukhin, 1075 Bradford Drive, Roswell, GA, 30076, US

(21) Appl. No.: 09/736,942

(22) Filed: Dec. 15, 2000

(51) Int. Cl. G09G 5/00

(52) U.S. Cl. 345/179

(57) ABSTRACT

A low-cost voting method is based on the dual input data entry paradigm, in which the voter is placed in traditional and familiar settings, such that the voter completes a paper ballot in the voting booth with a marking digital stylus and the input is immediately recorded by a digitizer tablet, on which the ballot is securely positioned, relayed to a central computer serving multiple booths, where the input is processed and stored for the final count.

### CROSS-REFERENCE TO RELATED APPLICATIONS

Application Ser. No. 09/579,477 Filing Date: May, 30, 2000

### STATEMENT REGARDING FEDERALLY SPONSORED RESEARCH OR DEVELOPMENT

N/A

### REFERENCE TO A MICROFICHE APPENDIX

N/A

### BACKGROUND OF THE INVENTION

The present invention relates to a computerized voting system. Voting has traditionally been a manual action, i.e. each voter has to make his/hers selection on the ballot by placing a mark with a writing instrument such as a pen or a pencil or by punching a hole next to the candidate's name. After the ballots are cast, they are counted by a machine, which scans the marks on the ballots or counts the punched holes depending on the ballot type. One of the major drawbacks of the system is the irreversibility of a human error. Once a voter makes an erroneous selection by accident and decides to correct the selection, the ballot will be discarded as invalid, because it will be impossible to make an accurate inference about the voter's intent in the traditional settings. Another drawback is a possibility of undercounting votes by the above-mentioned machines for various technical reasons.

A number of computerized voting methods have been proposed predominantly based on a touch screen technology and Internet technology. Although the systems seem to resolve the drawbacks of the traditional method, they all raise new concerns. The major concern related to the Internet technology is security. Although, the issue has been addressed in a number of earlier proposals, the solutions are expensive and not full proof. High cost is a common drawback of the on-site computerized systems. In addition, the introduction of the computerized system dramatically changes the traditional voting settings, which may have a detrimental effect on voters. The format of voting and the new presentation of choices can raise the anxiety levels, especially in older voters, which in turn will prompt erroneous selection. In cognitive and neuropsychological testing, where a similar problem exists and it is especially important to reduce anxiety caused by the testing environment, in particular, digital recording equipment (tape-recorders, computers of various kinds), we have been successfully using a dual input paradigm. A system based on a dual input paradigm allows to preserve the traditional input setting, in which the user (a patient, a voter, etc.) can write in a familiar manner on paper with an ink pen, for example, and to record the input in the digital format and to process it immediately on a computer. This paradigm has allowed us to place the test participants in familiar settings and keep them unaware of being recorded by a computer. At the same time, we have been able to get many valuable variables describing the test participants' performance, which are unattainable by the conventional testing techniques.

### BRIEF SUMMARY OF THE INVENTION

It is thus an object of the present invention to provide a smother and more cost effective transition from the conventional voting technique to the computerized voting with the system, which reduces the human error due to the anxiety of using new methods and machines in particular by keeping the traditional voting settings, which is less costly then the alternative computerized voting solutions and offers a comparably extensive functionality.

It is yet another an object of the present invention to provide a hybrid method of voting, which combines the traditional setting with a paper ballot, on which selection has to be maid by a marking writing instrument, with the digital input technology, which allows an expedient, accurate, and extensive processing of the voter's selection.

It is yet another object of the present invention to eliminate errors, which occur in the conventional voting methods during selection and/or count by providing a fault tolerant interpretation of the voter's intent.

It is yet another object of the present invention to provide an interactive audio support for picking candidates, which would be beneficial for the general voter and for voters with reading impairments, in particular.

### BRIEF DESCRIPTION OF THE DRAWINGS

FIG. 1 offers a general view of the system with multiple terminals and the central computer servers.

FIG. 2 is a detailed view of the upper panel of the voting terminal.

### DETAILED DESCRIPTION OF THE INVENTION

The proposed method of voting is based on the dual input paradigm, whereas a voter makes the selection of candidates with a marking digital stylus on a paper ballot and the input is immediately captured by a digitizer tablet under the ballot and sent for processing and storage to a central computer server.

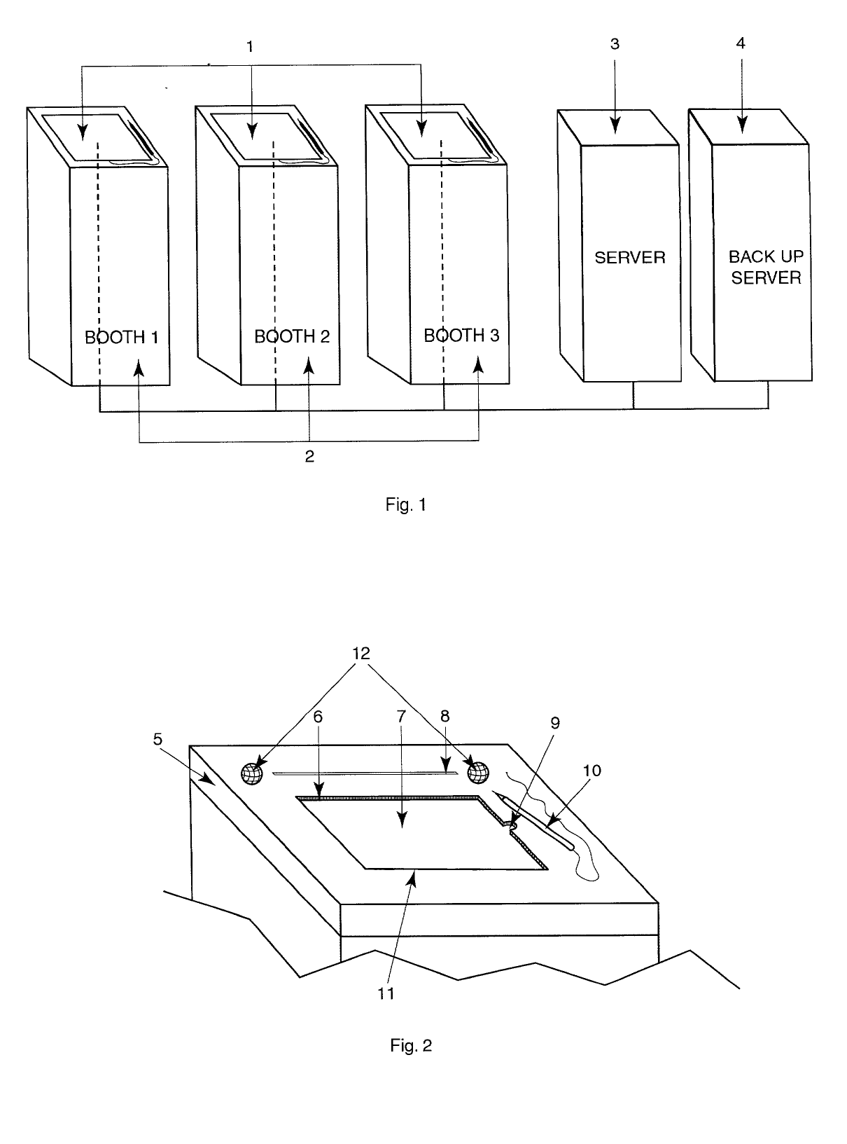

First, the components of the computerized voting system are explained. The entire computerized voting system (FIG. 1) comprises a plurality of digitizer tablets (1), each located in a voting booth (2), and a central computer server (3), with a back-up server (4). The said digitizer tablets are connected to the said servers by means of cables via a USB, FireWire, or SCSI ports, thus forming a net of independent devices talking to the said servers using a high-speed connection. The software package, which subserves the voting and analyzes the results, is installed on the said servers.

Each booth is equipped with a stand, in which the upper panel (5) houses the said digitizer tablet. (FIG. 2). The digitizer tablet is sunken into the said upper panel (5) of the stand, such that the surface of the said digitizer (7) is lower than the surface of the upper panel and only the active area of the said tablet is exposed. The height difference (6) ensures that the ballot, which has the same surface as the active areas of the digitizer, when placed on the said digitizer, is secured and cannot be moved sidewise. On one of the sides of the opening (11), in which the said digitizer is inserted, there provided a groove (9) with the depth equal to difference (6) between the surface of the upper panel and the digitizer's surface. The said groove is provided for easy removal of the ballot from the digitizer's surface. The said upper panel is provided in a tilted position, such that the edge, which is farthest from the voter, is higher than the most proximate edge of the panel, in order to facilitate reading and marking the ballot.

On the said upper panel (5) there is also provided a slot (8) for casting ballots. Inside the slot there are two electrodes, emanating from the said digitizer tablet (7). The said electrodes are in contact by default.

The said stand is hollow with the inner space used for collecting the cast ballots. The said stand is secured during voting, but can be opened using an opening in a side at the bottom for the removal of ballots or by opening the said upper panel (5) for installation or maintenance of the equipment.

There is also provided a multifunctional marking stylus (10), which can leave marks in ink, lead or other marking materials, depending on the requirements of the ballot machines, which can be utilized at a later stage, if necessary, for counting ballots, recounts or/and comparative counts. The said stylus can be connected to the said upper panel of the stand by a chain or rope of sufficient length for security.

There is also provided one or more optional speakers (12) inserted in the said upper panel of the said stand and connected to the said central server.

Next the application of the said computerized voting system is explained. The software package, which resides during voting on the central server, comprises three modules—for ballot design, voting administration, and processing of the results. The design module enables to design a uniform ballot, print it, store its graphical representation in order to retrieve and use it at run-time during the voting. The ballots are designed and printed on paper of the size equal to the active surface of the digitizer tablet. Prior to entering a voting booth or in a voting booth, the voter receives a ballot from an election official or an electronic ballot distribution system, which can be used in concert with the object of the present invention. The voter places the ballot on the sunken surface of the digitizer in the upper panel of the stand. As soon as the user touches the surface of the ballot with the tip of the marking stylus, the software receives the signal from the digitizer and begins data recording for that voter. Each stylus move on the surface of the ballot is picked up by the digitizer and relayed to the said central server, where the program identifies the digitizer, time-stamps the input, and maps it onto the digital representation of the ballot in memory. As the program keeps the ballot's layout in memory, the location of each stroke or mark in relation to the part of the ballot is known. If one candidate receives multiple marks, the last selection overrides the previous ones. If more than one competing candidate was marked, the program registers all entries with time-stamps, giving preference to the most recent selection.

If the optional speakers are provided in the booth, the program will be sending interactive audio messages, which were recorded at the design phase. The messages will be sent if the pen is hovering over the candidates name or the area designated for selecting the candidate. In that case, the user can, for example, be notified that he/she is about to select the specific candidate(s) calling them by name(s). A confirmation message can be dispatched, after the mark has been placed next to a candidate's name. In that case, the user can be notified, that he/she has selected the candidate, specifying the candidate's name. Following a correction, the program can notify the voter that he/she changed his/hers selection from one candidate to the other, calling both candidates by name. After the voter completes the ballot, the ballot is cast through the slot (8). While the ballot passes through the slot, the said electrodes are temporarily separated, which triggers a special signal from the said digitizer tablet to the said central server. The software receives the signal, identifies the sending tablet and interprets the signal as the end of voting and saves the data in the database, where all voting data (e.g. booth number, voter's ID, timestamps of selections, selection values, and status of selection) are stored, and prepares for the next voter by reinitializing appropriate values. After the ballot has passed the slot, the electrodes are connected again, till the next voter casts the ballot. The program can dispatch an optional audio message at that time.

Now the operation with multiple ballots is explained. The ballot designer in the software package makes it possible to create multiple ballots for an individual voter, reflecting different election categories. The program offers several templates, which differ by the location of the designated areas in which the marks have to be placed by voters. In the multiple ballot case, the program forces the ballot designer to pick different

### DETAILED DESCRIPTION OF THE INVENTION

The proposed method of voting is based on the dual input paradigm, whereas a voter makes the selection of candidates with a marking digital stylus on a paper ballot and the input is immediately captured by a digitizer tablet under the ballot and sent for processing and storage to a central computer server.

First, the components of the computerized voting system are explained. The entire computerized voting system (FIG. 1) comprises a plurality of digitizer tablets (1), each located in a voting booth (2), and a central computer server (3), with a back-up server (4). The said digitizer tablets are connected to the said servers by means of cables via a USB, FireWire, or SCSI ports, thus forming a net of independent devices talking to the said servers using a high-speed connection. The software package, which subserves the voting and analyzes the results, is installed on the said servers.

Each booth is equipped with a stand, in which the upper panel (5) houses the said digitizer tablet. (FIG. 2). The digitizer tablet is sunken into the said upper panel (5) of the stand, such that the surface of the said digitizer (7) is lower than the surface of the upper panel and only the active area of the said tablet is exposed. The height difference (6) ensures that the ballot, which has the same surface as the active areas of the digitizer, when placed on the said digitizer, is secured and cannot be moved sidewise. On one of the sides of the opening (11), in which the said digitizer is inserted, there provided a groove (9) with the depth equal to difference (6) between the surface of the upper panel and the digitizer's surface. The said groove is provided for easy removal of the ballot from the digitizer's surface. The said upper panel is provided in a tilted position, such that the edge, which is farthest from the voter, is higher than the most proximate edge of the panel, in order to facilitate reading and marking the ballot.

On the said upper panel (5) there is also provided a slot (8) for casting ballots. Inside the slot there are two electrodes, emanating from the said digitizer tablet (7). The said electrodes are in contact by default.

The said stand is hollow with the inner space used for collecting the cast ballots. The said stand is secured during voting, but can be opened using an opening in a side at the bottom for the removal of ballots or by opening the said upper panel (5) for installation or maintenance of the equipment.

There is also provided a multifunctional marking stylus (10), which can leave marks in ink, lead or other marking materials, depending on the requirements of the ballot machines, which can be utilized at a later stage, if necessary, for counting ballots, recounts or/and comparative counts. The said stylus can be connected to the said upper panel of the stand by a chain or rope of sufficient length for security.

There is also provided one or more optional speakers (12) inserted in the said upper panel of the said stand and connected to the said central server.

Next the application of the said computerized voting system is explained. The software package, which resides during voting on the central server, comprises three modules—for ballot design, voting administration, and processing of the results. The design module enables to design a uniform ballot, print it, store its graphical representation in order to retrieve and use it at run-time during the voting. The ballots are designed and printed on paper of the size equal to the active surface of the digitizer tablet. Prior to entering a voting booth or in a voting booth, the voter receives a ballot from an election official or an electronic ballot distribution system, which can be used in concert with the object of the present invention. The voter places the ballot on the sunken surface of the digitizer in the upper panel of the stand. As soon as the user touches the surface of the ballot with the tip of the marking stylus, the software receives the signal from the digitizer and begins data recording for that voter. Each stylus move on the surface of the ballot is picked up by the digitizer and relayed to the said central server, where the program identifies the digitizer, time-stamps the input, and maps it onto the digital representation of the ballot in memory. As the program keeps the ballot's layout in memory, the location of each stroke or mark in relation to the part of the ballot is known. If one candidate receives multiple marks, the last selection overrides the previous ones. If more than one competing candidate was marked, the program registers all entries with time-stamps, giving preference to the most recent selection.

If the optional speakers are provided in the booth, the program will be sending interactive audio messages, which were recorded at the design phase. The messages will be sent if the pen is hovering over the candidates name or the area designated for selecting the candidate. In that case, the user can, for example, be notified that he/she is about to select the specific candidate(s) calling them by name(s). A confirmation message can be dispatched, after the mark has been placed next to a candidate's name. In that case, the user can be notified, that he/she has selected the candidate, specifying the candidate's name. Following a correction, the program can notify the voter that he/she changed his/hers selection from one candidate to the other, calling both candidates by name. After the voter completes the ballot, the ballot is cast through the slot (8). While the ballot passes through the slot, the said electrodes are temporarily separated, which triggers a special signal from the said digitizer tablet to the said central server. The software receives the signal, identifies the sending tablet and interprets the signal as the end of voting and saves the data in the database, where all voting data (e.g. booth number, voter's ID, timestamps of selections, selection values, and status of selection) are stored, and prepares for the next voter by reinitializing appropriate values. After the ballot has passed the slot, the electrodes are connected again, till the next voter casts the ballot. The program can dispatch an optional audio message at that time.

Now the operation with multiple ballots is explained. The ballot designer in the software package makes it possible to create multiple ballots for an individual voter, reflecting different election categories. The program offers several templates, which differ by the location of the designated areas in which the marks have to be placed by voters. In the multiple ballot case, the program forces the ballot designer to pick different layouts for different ballots. The differences in the layout enable the program to determine at run-time what ballot is being filled out.

While I have described above the principles of my invention in conjunction with a specific dual input notebook computer, it is to be clearly understood that this description is made only by way of example and not as a limitation of the scope of my invention as set forth in the accompanying claims.

1. A method of dual input data entry, whereas the data are entered on a writing surface such as paper with a marking writing instrument and are being instantly recorded and processed by a computer.

2. A digital voting system, which utilizes the dual input data entry defined in claim 1.

3. The digital voting system as defined in claim 2, comprising a plurality of voting terminals, which immediately transfer the voter's input in a digital format to a central computer server and a number of back up computer servers, on which a special software program resides.

4. A voting terminal, mentioned as a part of the voting system in claim 3, comprising:
a secured stand with a slot in which completed ballots are cast;
a digitizer tablet inserted in the upper panel of the stand;
means to secure a ballot on the said digitizer's surface, such that the user's input is not obstructed and the ballot when placed on the digitizer does not move sidewise, so that the graphical forms on the ballot can be accurately mapped on to their digital representations maintained by the afore mentioned software program in the central computer server, as defined in claim 3;
a marking digital stylus, capable of leaving marks in lead or ink or other acceptable marking substance on the ballot's surface and sending digital signals to the said receiving digitizer tablet under the ballot, which are then relayed by the said digitizer to the said central server;

5. The said digitizer tablet, mentioned in claim 4, has its surface positioned lower than the surface of the upper panel of the stand, in which it located, to the extent that the ballot when placed on the digitizer does not move sidewise and the height difference does not obstruct user's input;

6. The voting terminal, as defined, in claim 4, in which the slot for casting ballots is equipped with two electrodes, emanating from the said digitizer's circuit and connected to each other in the default position in such a manner that the contact is broken when a ballot is cast through the slot and a signal with a reserved value is sent to the said central server, indicating that the voter has cast his or hers ballot and his/hers selection of the candidates is complete.

7. The voting terminal, as defined in claim 4, which has one or more speakers, inserted in the upper panel of the stand, for translating interactive messages.

8. A software package, residing on the said central server and capable of recording, time-stamping, and processing the user's selection for each election category by mapping the coordinates of the user's input, provided by the digitizer onto the ballot's representation in the computer memory, and storing the processed data in the database for subsequent summarization.

9. The software package, as defined in claim 8, with the flexibility of recording all selection attempts of the voter for a particular election category without limitation and conducting the final count of votes based on the predefined rules as to which selection, if multiple selections within a category are permissible, should be counted toward the final total.

10. The software package, as defined in claim 9, which sends audio messages prerecorded during the design phase to the said speakers in the said terminal, after the pen is pointing at or hovering over a candidates name or an area designated for selecting the candidate, as well as immediately following the selection of the candidate, to notify the voter as to what selection the voter is about to make or has already made.
